(19) United States
(12) Patent Application Publication
(10) Pub. No.: US 2006/0181397 A1
(43) Pub. Date: Aug. 17, 2006

(54) Method and apparatus for associating randomized identifiers with tagged assets

(76) Inventor: Praveen Limbachiya, Wellesley, MA (US)

Correspondence Address: WOLF GREENFIELD & SACKS, PC, FEDERAL RESERVE PLAZA, 600 ATLANTIC AVENUE, BOSTON, MA, 02210-2206, US

(21) Appl. No.: 11/355,786

(22) Filed: Feb. 16, 2006

Related U.S. Application Data
(60) Provisional application No. 60/653,852, filed on Feb. 17, 2005.

(51) Int. Cl. H04Q 5/22; G06F 17/00

(52) U.S. Cl. 340/10.51; 235/375

(57) ABSTRACT

Item identification numbers used in RFID tags for items may include a randomized component, i.e., a randomized identifier. The identification number may be in an EPC or any other suitable format. Identification numbers including a randomized identifier may make it difficult to anticipate or otherwise guess the identification numbers for all items in a group based on only the knowledge of identification numbers for a few items in the group.

### BACKGROUND OF INVENTION

1. Field of Invention

The invention is directed to the use of randomized identification numbers or other identifiers in radio frequency identification (RFID) tags.

2. Discussion of Related Art

An electronic tag typically is affixed to or otherwise associated with an item to be tracked or identified. Such tags may be implemented using a family of technologies that facilitate the transfer of data wirelessly between tagged items and electronic readers. For example, radio frequency identification (RFID) tags have radio antennas which are capable of transmitting data. Such RFID tags, when used with a tag reader, allow tracking and/or identification of tagged items.

To uniquely identify tagged items, a naming system referred to as the electronic product code (EPC) has been developed. The EPC was created to accommodate current and future naming methods, and is intended to be universally and globally accepted as a means to link physical items to a computer network and to serve as an efficient information reference. A unique EPC assigned to an item to be tracked may be stored in an RFID tag as a binary number of 64 or 96 bits long. (As used herein, a “number” can include numbers, letters or other suitable characters.) In particular, the EPC bit string is intended to uniquely identify an item by encoding the manufacturer, the type of item, and the item serial number, for example.

An example 100 of an EPC is shown in FIG. 1. The first field 102 is known as the header, and may identify which EPC standard is being used. The second field 104 is known as the EPC manager, and may be encoded with a manufacturer identification number. The third field 106 is the object class, and may be encoded with the type of item. The fourth field 108 is known as the serial number, and may be encoded with an identification number that uniquely identifies an individual item in a set of related items.

When queried (e.g., by a tag reader), the RFID tag may wirelessly transmit a representation of the EPC to the tag reader, which may decode and display information such as the manufacturer, item type, and/or serial number and/or send the received information to one or more other processing devices for decoding and subsequent routing. One such processing device that may receive communications from a tag reader (e.g., via a wireless local area network or other communications system) commonly is referred to as an object naming service (ONS).

The object naming service (ONS) can link the electronic product code (EPC) with one or more associated data files containing information relating to the tagged item. More specifically, the ONS is an automated networking service which, when given an EPC, returns a network address at which one or more data files corresponding to the tagged item may be located. The ONS is based on the concept of the standard domain naming service (DNS) used to identify website addresses based on a website name. In particular, the ONS parses the EPC to decode particular information in specific fields of the EPC (e.g., the serial number, as shown in FIG. 1) so as to return the appropriate address where data is located.

A physical markup language (PML) is a standard in which network information about physical items may be written. PML essentially is an XML-based language for databasing information about physical items, and is designed to standardize descriptions of physical items for use by both humans and machines. In one aspect, PML serves a common base for software applications, data storage and analytic tools for industry and commerce. As discussed above, once the ONS decodes an EPC, it returns an address to a PML server which includes one or more databases in which are stored one or more files containing information regarding the tagged item. The PML server accesses this information and provides a standardized data output regarding the tagged item using PML, which may be forwarded back to the tag reader. A user may review this information, e.g., to determine the manufacturer of a particular item, the serial number of the item with the day and time

### SUMMARY OF INVENTION

The inventor has appreciated a problem with current RFID systems, i.e., that a set of item identification numbers used with a corresponding set of tagged items may be easily anticipated by reading one or a few item identification numbers. The inventor has appreciated that current RFID systems are vulnerable to unauthorized persons reading the item identification numbers from RFID tags, gaining information related to the corresponding items, and using this information for unintended purposes.

In one example scenario envisioned by the inventor, an attempt may be made to replace a shipment of genuine items with a counterfeit shipment. In standard RFID systems, the identification numbers included with each of the items in the shipment may include sequential serial numbers. By reading a few of the item identification numbers in the shipment, one may be able to guess the entire batch of item identification numbers for the items in the shipment. Using this information, counterfeit items may be supplied with tags that have the same identification numbers as the genuine items and be used to replace the genuine items. Since the identification numbers on the counterfeit items are the same as the genuine items, later recipients of the shipment may not discover that the shipment in fact includes counterfeit items.

In another example, the inventor has noted that typical RFID technology may use identification number formats that provide readily accessible information to unintended parties. For example, if an item is tagged with an RFID tag having an identification number in standard EPC format, the identification number may be read, and knowledge about the contents of a shipment may be obtained by accessing information provided by an ONS or otherwise. Such knowledge may include the name of the manufacturer, the value of an item, or other product information, for example.

In one aspect of the invention, a method of identifying a plurality of items includes generating a set of randomized identifiers, each of the randomized identifiers being unique from other randomized identifiers in the set of randomized identifiers. The randomized identifiers may each be included in a corresponding one of a plurality of RFID tags. Each of the RFID tags may be physically associated with a corresponding one of the plurality of items. Thus, a plurality of related items, e.g., items grouped together for shipment, may include tags that have an identification number including a randomized identifier, potentially making it difficult to determine the identification numbers of all items in the group based on knowledge of one or a few of the identification numbers.

In another aspect of the invention, a method of identifying a plurality of items includes generating a set of randomized identifiers, each of the randomized identifiers being unique from other randomized identifiers in the set of randomized identifiers. A plurality of RFID tags is provided where each of the RFID tags contains a unique item identification number. Each unique item identification number is arranged to at least partially include a corresponding randomized identifier from the set of randomized identifiers.

In one embodiment, each of the randomized identifiers in the set of randomized identifiers has a corresponding non-randomized identifier. At least one of the plurality of RFID tags may be communicated with to obtain its corresponding unique item identification number, and the non-randomized identifier that corresponds to the randomized identifier included in the unique item identification number may be determined. The non-randomized identifier may be determined by decrypting the randomized identifier (e.g., using a known key or decryption algorithm) or by accessing a list that includes the randomized identifiers and their corresponding non-randomized identifiers.

In another aspect of the invention, a method of identifying a plurality of items includes providing a plurality of items with associated RFID tags so that the RFID tags each contain a unique item identification number from a set of item identification numbers. Each unique item identification number may be arranged to at least partially include a randomized identifier from a set of randomized identifiers. Each of the RFID tags may be physically associated with a corresponding one of a plurality of items, and the unique item identification numbers may be read from the associated RFID tags.

In another aspect of the invention, a set of unique item identification numbers may be stored on a plurality of RFID tags, where each unique item identification number at least partially includes a randomized identifier. The unique item identification number may be in EPC format, and all or part of the EPC format identification number may include a randomized identifier.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows an example of an EPC.

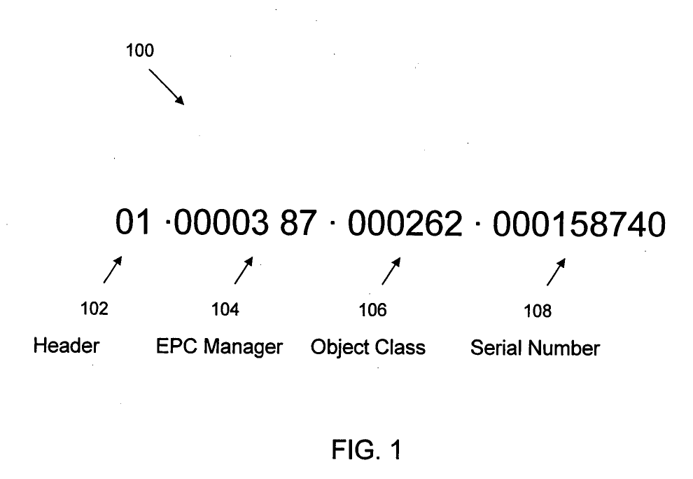

FIG. 2 shows a list of sequential EPC-type serial numbers and corresponding randomized identifiers.

FIG. 3 is a diagram which illustrates the implementation of an embodiment of the invention.

FIG. 4 shows examples of sequential item identification numbers including no randomized component and corresponding item identification numbers including a randomized identifier portion.

### DETAILED DESCRIPTION

Aspects of the invention are not limited in their application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

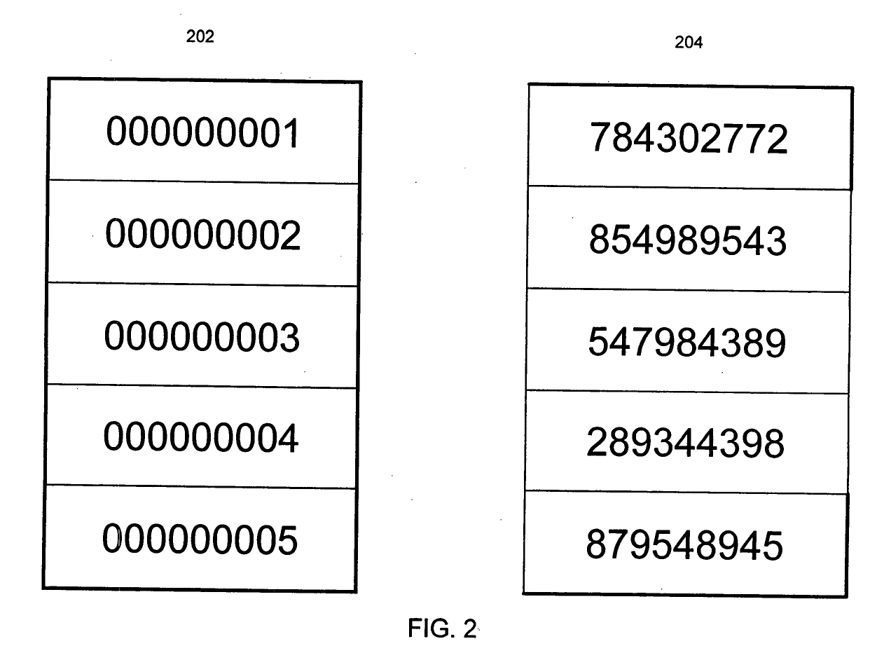

As discussed above, the inventor has appreciated potential problems with standard RFID systems for identification of items. For example, groups of items provided with RFID tags have item identification numbers stored in the tags, e.g., so that manufacturers, distributors, and retailers can tell them apart and/or obtain information about the items. Often these identification numbers are provided in sequential form, like the serial numbers 202 shown on the left side of FIG. 2. (Although only five serial numbers are shown in the left side of FIG. 2, these numbers may be part of a larger set of numbers, e.g., 50, 100, 1000, or more, each associated with a tag for a corresponding item.) As discussed above, sequential serial numbers in this type of arrangement can cause problems of various types, e.g., the set of numbers may be predicted and/or information about items may be discovered by reading one or a relatively small number of tags from a larger group of tagged items.

In accordance with the invention, randomized identifiers may be generated and included in item identification numbers associated with a plurality of related items. The word “randomized” as used herein means that a set of numbers is not easily determined from knowledge of one or a few numbers in the set. A randomized item identification number is an item identification number which at least partially includes a randomized identifier. A non-randomized item identification number is an item identification number that does not include a randomized identifier. Randomized identifiers may prevent the item identification numbers (or at least a randomized portion) from being easily predicted based on one or a few numbers in the set. The right side of FIG. 2 shows a plurality of randomized identifiers 204, i.e., five randomized identifiers that each correspond to one of the non-randomized serial numbers on the left. Even if one or a few of the randomized identifiers in the set of randomized identifiers is known, it may not be easy to predict the remaining identifiers in the set because the numbers do not necessarily follow a readily discernable pattern. Thus, the randomized identifiers on the right side of FIG. 2 may be used in the RFID tags of the corresponding items in place of the sequential serial numbers shown on the left side of FIG. 2.

In one example, a shipment of related items may be shipped from a first entity to a second entity. The first entity may provide a unique, randomized identifier to be included in an item identification number that is stored on a RFID tag associated with each item. When the second entity receives the shipment of items with corresponding RFID tags, an RFID reader may be used to read the item identification numbers including the randomized identifiers from the RFID tags. To verify the authenticity of the items in the shipment, the item identification numbers for the items that were received by the second entity may be compared to the item identification numbers for the items that were sent by the first entity, e.g., by the second entity comparing item identification numbers read from the items to a list of item identification numbers provided by the first entity. This step of verifying the item identification numbers may allow the second entity to check that the shipment of correct and/or authentic items has been received.

In one embodiment, a third-party randomized numbering service may perform the verification of the shipment. This service may provide the randomized identifiers for the shipment to the first entity, which are then used in the tags for the items. The second entity may send a list of the item identification numbers for the received items, and the numbering service may compare the randomized identifiers provided to the first entity to the randomized identifiers included in the item identification numbers provided by the second entity. By using a third-party service, knowledge regarding how the randomized identifiers are generated may be kept from both the first and second entities, potentially increasing security.

If the item identification numbers are in an EPC format, the second entity may obtain information related to the items in the shipment, e.g., by sending the item identification numbers to an ONS and reading the data files that may contain information related to the corresponding items. This assumes that the portion of the EPC relative to which the second entity wishes to receive information does not include a randomized identifier. If so, the second entity could determine the non-randomized number that corresponds to the randomized identifier, e.g., by decrypting the randomized identifier or determining the corresponding non-randomized number from a correspondence chart or other list provided by the first entity. Alternately, the third-party service could receive item identifiers including randomized identifiers from the second entity and provide corresponding non-randomized identification numbers and/or addresses for ONS-type information.

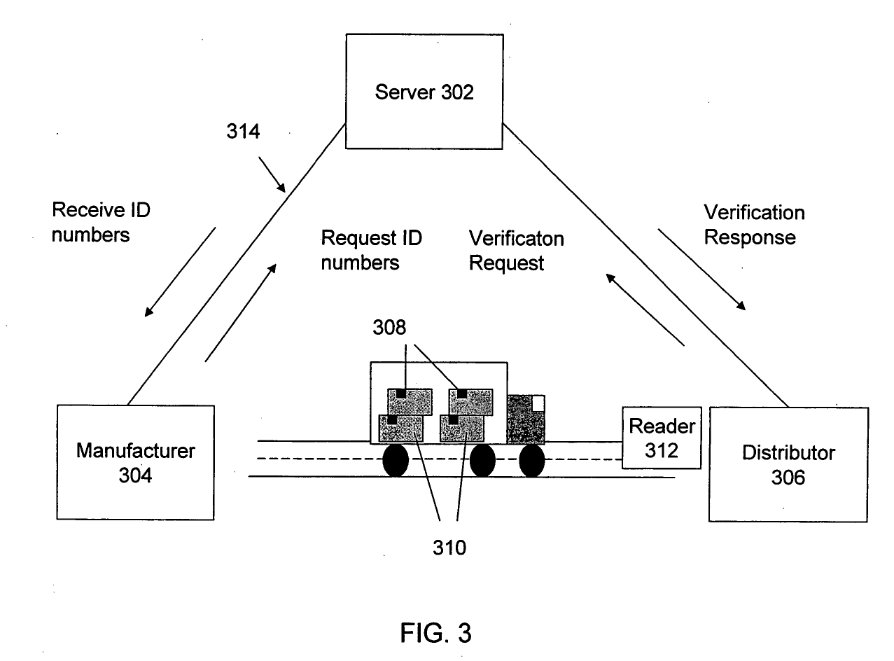

FIG. 3 shows a diagram that depicts one embodiment of the invention. In this embodiment, a manufacturer 304 wishes to send a plurality of items 310 to a distributor 306. As a first step, the manufacturer may send a request for a plurality of randomized identifiers through an electronic network 314, e.g., the Internet, to a server 302. The server 302 may be operated by a service that provides randomized identifiers upon request. The randomized identifiers may be generated according to specifications required by the manufacturer, such as including a maximum number of bits, generated using a specific form of encryption and/or using a specific key or set of keys, etc. The manufacturer may also provide a list of non-randomized numbers, such as a list of sequential serial numbers, and request that the randomized identifiers each be associated with one of the sequential serial numbers. The server may respond by generating and sending a set of randomized identifiers to the manufacturer through the electronic network 314, e.g., by using the serial numbers provided by the manufacturer as keys and using an encryption algorithm to generate a corresponding randomized identifier for each serial number. Upon receiving the identifiers, the manufacturer may then store on each of a plurality of RFID tags a unique item identification number that at least partially includes one of the randomized identifiers supplied by the server 302. Each of the tags may then be associated with corresponding ones of a plurality of related items, and the items loaded onto a truck or otherwise shipped to a distributor 306.

Once the shipment of items reaches the distributor, an RFID reader 312 or other suitable device may be used to read the item identification numbers from the plurality of RFID tags, e.g., by bringing the RFID tag associated with an item into proximity with the RFID reader. By reading the RFID tags, the distributor may obtain the item identification numbers associated with each of the items in the shipment. If the identification numbers are in EPC format, the distributor may send the item identification numbers to an ONS to obtain information related to the items, such as the manufacturer or type of item. If the manager, object class or serial number portion of the identification numbers include a randomized identifier, the distributor may be required to decrypt the randomized identifier or otherwise determine the corresponding non-randomized number that corresponds to the randomized identifier in each identification number before being able to obtain ONS information. The server 302 may provide the non-randomized numbers that correspond to the randomized identifiers upon request from the distributor 306.

In one aspect of the invention, the distributor may wish to verify that the correct items have been received. To this end, the distributor may send the item identification numbers (e.g., the version including the randomized identifiers) to the server 302 via an electronic network. When the server receives the item identification numbers it may then respond to the distributor to verify whether the item identification numbers that have been read by the distributor and sent to the server are the same item identification numbers that were provided to the manufacturer. By verifying the item identification numbers, the distributor may verify the authenticity of the corresponding items in the shipment.

A set of randomized identifiers may be generated in any suitable way, which may depend on the application in which the randomized identifiers will be deployed. In one example, a computer algorithm may be used to pick a randomized set of numbers using a random number generator. In another example, a computer algorithm may pick values from a specified set of sources, such as stock values from a stock exchange, and use those values to obtain random numbers. Randomized identifiers need not necessarily be generated using a random number generator. For example, randomized identifiers may be generated using cryptography, e.g., using one or more keys to generate a plurality of numbers using known cryptography algorithms. In short, any suitable method may be used to generate randomized identifiers such that it is relatively difficult to determine a set of numbers from the knowledge of one or a few numbers in a set of randomized identifiers.

In one implementation, each randomized identifier may be generated by encryption using a corresponding key, such as an original product or serial number. This may allow later decryption of the randomized identifier to determine the root key, e.g., the corresponding original product or serial number. In another implementation, each randomized identifier may be generated by encrypting a product or serial number. An advantage of encryption may be increased difficultly in determining the relationship between a set of randomized identifiers without knowing the key(s) or other details about the encryption scheme. Any suitable encryption standard may be used, e.g., the Advanced Encryption Standard (AES). Additionally, any suitable encryption algorithm may be used. In some aspects of the invention, using an RSA cryptography algorithm may be advantageous. Additionally, any suitable key size may be used. In some cases, the key size may be large enough such that the encryption may be difficult to break, e.g., a 1024 bit key. It is possible that an encryption operation may generate a number that is larger than the storage space available on the RFID tag. If the number is too large, any suitable algorithm such as a modulo algorithm, e.g., Barrett, Montgomery, or classical, may be used to decrease the size of the number. Once a set of randomized numbers are generated they may each be incorporated into a RFID tag as a randomized identifier. The Appendix provides additional info regarding various approaches that may be used in aspects of the invention.

Item identification numbers stored in RFID tags may be provided in an EPC format, a modified EPC format, or another arrangement. For example, all or part of the EPC used in an RFID tag may contain a randomized identifier. Using a randomized identifier in at least part of the EPC may make it more difficult for unauthorized persons to gain item information (at least with respect to the portion of the EPC that includes the randomized identifier) and to determine item identification numbers for a set of related items.

In one embodiment, the serial number portion of an EPC for tagged items may be randomized, but the rest of the EPC may remain in the standard format. As discussed above, each of the items may use its original serial number as a key or otherwise as part of an encryption process to determine its corresponding randomized identifier. Alternately, the randomized identifier assigned to each item may have no relation to an earlier assigned serial number, if any.

In another embodiment, other parts of the EPC, such as the EPC manager and/or object class portions may be randomized instead of or in addition to the serial number. In the example above, the manufacturer may be concerned that someone may use a tag reader to look for a shipment of expensive items, e.g., plasma televisions. The manufacturer may choose to randomize the “object class” field of the EPC which may typically be encoded with the class of item, e.g., a product number representing the particular type of plasma television. Thus, randomizing the object class may conceal the type of the items being shipped. The manufacturer may also choose to randomize the EPC manager field of the EPC. Randomizing the EPC manager field may conceal the identity of the manufacturer and/or prevent competitors from gaining knowledge of a shipment. If such fields of an EPC are randomized for a shipment or other group of related items, each of the items may use the same randomized identifier in the manager or object class fields, if desired.

The EPC format may also be modified as desired when randomizing portions of an EPC. For example, a manufacturer may choose not to include the object class portion in the EPC identification numbers used on a shipment of particular items. Instead, bits in the object class portion of the EPC may be used for other purposes, such as to encode a longer randomized identifier for the serial number. If the serial number is encrypted including the extra bits from the object class portion, the encrypted serial number may be more difficult to decrypt. Such a configuration may provide added security in some applications.

In another embodiment, the entire EPC may be randomized. Randomizing the entire EPC may be useful in an application where the header portion of the EPC may not be needed, e.g., where the items are to be tracked and/or identified by a single organization. For example, a firm may wish to associate RFID tags with a plurality of files. Since the RFID tags are not intended to be read by anyone outside the firm, it may not be necessary to provide the header field of the EPC since the format would be known to those in the firm. Additionally, the EPC manager and object class portions of the EPC may not be necessary in this application because there may be only one manufacturer (e.g., the firm) and only one class of item (e.g., files). Randomizing the entire EPC may provide a higher level of security because unauthorized persons may not have knowledge of the location of information in the EPC, making it more difficult to intercept information from the RFID tag. If the entire EPC is randomized using an encryption process, then a larger number of bits may be available for the encryption, and the EPC may be more difficult to decrypt.

In some applications, it may be desirable to use randomized identifiers during part of a lifecycle of a group of items and to use non-randomized numbers for another part of the lifecycle. For example, it may be desirable to use non-randomized item identification numbers, e.g., sequential serial numbers like that in FIG. 2 under item 202, at some times because non-randomized item identification numbers may make it easier to track and/or locate items, e.g., when they are stored in the manufacturer's warehouse. However, at another time, it may be desirable to replace the non-randomized item identification numbers with identification numbers including a randomized identifier, e.g., when shipping the items to a customer. Replacing non-randomized item identification numbers with corresponding randomized item identification numbers (e.g., having a randomized identifier portion) may be done, for example, by re-programming each of the RFID tags with the new identification numbers. Alternately, the RFID tags themselves may be replaced with tags having the desired item identification number.

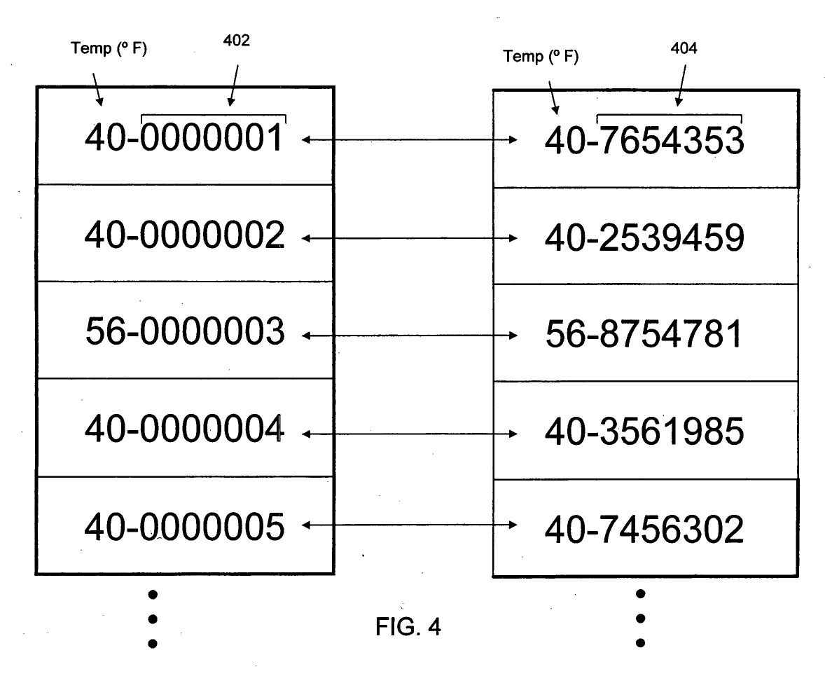

In one illustrative embodiment that illustrates the use of non-randomized and randomized identification numbers, a plurality of vaccine containers are stored in a warehouse, where each vaccine container has a corresponding RFID tag and a non-randomized item identification number. The RFID tags associated with the vaccine containers may be of the type that sense an environmental parameter, e.g., temperature, and store a representation of the environmental parameter. The tag for each vaccine container may be checked (e.g., with a tag reader) to determine if the container has reached an unacceptably high temperature level so that that appropriate action can be taken. One example of an encoding arrangement that may be used to store the representation of temperature is shown in FIG. 4. The temperature representation may be encoded in the first two numbers in an identification number, e.g., the serial number portion of an EPC. The dashes in FIG. 4 are shown for clarity and need not necessarily be used. It is to be appreciated that any suitable encoding may be used.

If the item identification numbers are non-randomized, e.g., the sequential item identification numbers 402 shown in FIG. 4 are used in the vaccine container tags, it may be easier in some cases to find the one or more vaccine containers that need to be removed, e.g., for a high temperature condition. For example, if the vaccine container with item serial number 0000003 is to be removed and the numbers are sequential, then the vaccine container with item serial number 0000003 may be physically located between the vaccine containers with item serial numbers 0000002 and 0000004.

During another part of the lifecycle of the vaccine containers, it may be desirable to use a set of randomized identifiers in place of the item serial numbers, e.g., during shipment of the vaccine containers. For example, a manufacturer may wish to send a shipment of vaccine containers to a distributor. Prior to shipment, the manufacturer may replace the item serial numbers 402 with randomized identifiers 404. The “temperature” portion of the identification number may not be randomized so that any party in the distribution chain can identify containers that have been exposed to unacceptably high temperatures. Once the shipment of vaccine containers reaches the distributor, the distributor may read the item identification numbers from the RFID tags, e.g., to verify the authenticity of the items in the shipment. The distributor may prefer to replace the randomized item identification numbers 404 stored in the RFID tags for each vaccine container with the corresponding non-randomized item identification numbers 402, or otherwise use the non-randomized identification numbers. The distributor may obtain the corresponding non-randomized numbers in any suitable way, such as by the manufacturer or randomized identifier generating service sending a list of randomized identifiers and their corresponding non-randomized serial numbers. The distributor may use this list as a lookup table, e.g., provide the list to a tag reader that reads the randomized identification numbers from tags and uses the lookup table to determine the non-randomized number and display the non-randomized number to an operator.

Alternatively, the distributor may generate a new set of item identification numbers and program the RFID tags with the new set of item identification numbers, e.g., non-randomized item identification numbers. The distributor may generate a new set of item identification numbers because, for example, the distributor may prefer a particular format for the numbers, e.g., a different EPC version, a modified EPC, etc.

In another aspect of the invention, a “randomized identifier” ONS service may be provided for users of tags with randomized identifiers. When using standard EPC identification numbers, a user can read the number from a tagged item and obtain information about the item from an ONS. However, using a randomized identifier in an EPC identification number may prevent users from gaining information from the ONS because the number in the EPC will not match any addresses or files in the ONS records. Thus, a “randomized ONS” service may be provided, e.g., by the server 302 or other similar apparatus, such that a user can send an EPC having a randomized identifier to the service, the service can determine the non-randomized identification number or other EPC portion that corresponds to the item, and provide an address for files regarding the item to the user. For example, the “randomized ONS” service may receive an EPC identification number and decrypt the randomized portion or use a lookup table to determine the non-randomized number that corresponds to the randomized identifier. Thereafter, the ONS may operate in a normal way, identifying the addresses and/or files that correspond to the item.

The RFID tags used in embodiments of the invention could be chosen from a variety of tag types. In various aspects of the invention, RFID tags could be active, passive, static, or programmable. The tags could be of the type used to sense an environmental parameter and to store information about the environmental parameter.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

### APPENDIX

Cryptography

One may use any suitable encryption standard. AES may be preferred since it is a worldwide standard. The Advanced Encryption Standard (AES), also known as Rijndael, is a block cipher adopted as an encryption standard by the US government, and is expected to be used worldwide and analyzed extensively, as was the case with its predecessor, the Data Encryption Standard (DES).

One may use any suitable encryption system. A symmetric system may be used if one wants to completely control the access of the keys. An asymmetric system (public/private key pair) may be used if one wants to supply the public keys to partners to encrypt the data. One may keep the private key to decrypt the data. The figure below illustrate the differences between symmetric and asymmetric encryption systems.

Any suitable cryptography algorithm may be used. In some cases, RSA cryptography may be preferable. Any suitable key size may be used. In some cases, 1024 bit keys may be preferred. 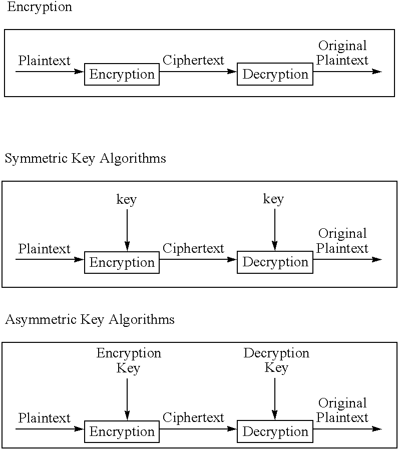
Truncation and/or Modulo Reduction

In one implementation, the size of the key, the plaintext, and/or encryption output may be truncated and/or modulo reduced in any suitable way to reduce the size of the number as appropriate.

For example, a modulo algorithm may be used to decrease the size of the encryption output to fit the available space in the RFID. Various types of encryption operations (symmetric, asymmetric, asymmetric with authentication, asymmetric with signature) may generate a number that is larger than the space available in the RFID. A modulo algorithm or other truncation methods may be used to decrease the size of the number. For example, various modulo algorithms (classical, Barrett and Montgomery to name a few) are available and any suitable one of them may be used to obtain the desired speed and quality. A database may store the generated smaller number and the original encrypted number. One way of using of modulo reduction to reduce the size of an encrypted number is illustrated in the figure below. 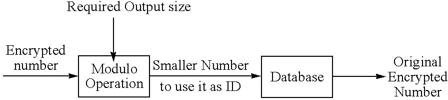
Authentication

In some cases, message authentication may be desirable for additional security. One may use any suitable digital signatures. The figures blow illustrate how a message authentication code and/or digital signature may be used for message authentication.

Note: The message may be an encrypted number but may be better protected by adding an authentication code.

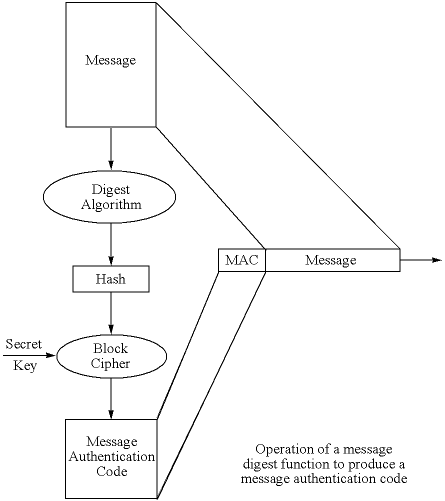

Note: The message may be an encrypted number but may be signed to show who sent the message.

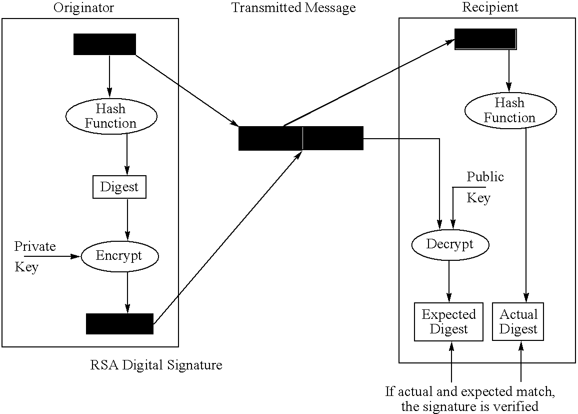

What is claimed is:

1. A method of identifying a plurality of items, comprising:
generating a set of randomized identifiers, each of the randomized identifiers being unique from other randomized identifiers in the set of randomized identifiers; and
providing the set of randomized identifiers to include each of the randomized identifiers in a corresponding one of a plurality of RFID tags, each of the RFID tags to be physically associated with a corresponding one of the plurality of items.

2. The method of claim 1, wherein providing the set of randomized identifiers comprises electronically sending the set of randomized identifiers.

3. The method of claim 1, wherein the set of randomized identifiers is provided to each be incorporated into a corresponding EPC format item identification number.

4. The method of claim 1, wherein generating the set of randomized identifiers at least partially comprises using an encryption process.

5. The method of claim 4, wherein the encryption process comprises using RSA cryptography.

6. The method of claim 1, further comprising communicating with one of the RFID tags using a tag reader to obtain a randomized identifier stored in the RFID tag.

7. The method of claim 1, wherein the RFID tags are adapted to sense at least one environmental parameter.

8. A method of identifying a plurality of items, comprising:
generating a set of randomized identifiers, each of the randomized identifiers being unique from other randomized identifiers in the set of randomized identifiers; and
providing a plurality of RFID tags, the RFID tags each containing a unique item identification number, each unique item identification number at least partially including a corresponding randomized identifier from the set of randomized identifiers.

9. The method of claim 8, further comprising recording each of the set of randomized identifiers in a memory of a corresponding one of the plurality of RFID tags.

10. The method of claim 8, wherein each of the randomized identifiers in the set of randomized identifiers has a corresponding non-randomized identifier, the method further comprising:
communicating with at least one of the plurality of RFID tags to obtain the corresponding unique item identification number, and
determining the non-randomized identifier that corresponds to the randomized identifier included in the unique item identification number.

11. The method of claim 8, further comprising:
physically associating each of the plurality of RFID tags with a corresponding one of a plurality of items.

12. The method of claim 8, wherein each unique item identification number is in an EPC format.

13. The method of claim 8, wherein generating the set of randomized identifiers at least partially comprises using an encryption process.

14. The method of claim 13, wherein the encryption process comprises using RSA cryptography.

15. The method of claim 8, wherein the plurality of RFID tags are passive or active tags.

16. The method of claim 8, wherein the plurality of RFID tags are adapted to sense at least one environmental parameter.

17. A method of identifying a plurality of items, comprising:
providing a plurality of items with associated RFID tags, the RFID tags each containing a unique item identification number from a set of item identification numbers, each unique item identification number at least partially including a randomized identifier from a set of randomized identifiers; and
reading the unique item identification numbers from the associated RFID tags, each of the RFID tags being physically associated with a corresponding one of a plurality of items.

18. The method of claim 17, further comprising programming individual RFID tags to replace the randomized identifier with a non-randomized identifier.

19. The method of claim 17, further comprising using an ONS to obtain information corresponding to the plurality of items.

20. The method of claim 17, further comprising verifying an authenticity of the item identification numbers associated with the plurality of items.

21. The method of claim 17, wherein the unique item identification numbers are in an EPC format.

22. The method of claim 17, wherein each in the set of randomized identifiers is formed at least partially using an encryption process.

23. The method of claim 22, wherein the encryption process comprises using RSA cryptography.

24. The method of claim 17, wherein the plurality of RFID tags are passive or active tags.

25. The method of claim 17, wherein the plurality of RFID tags are adapted to sense at least one environmental parameter.
